(19) United States
(12) Patent Application Publication
(10) Pub. No.: US 2009/0109138 A1
(43) Pub. Date: Apr. 30, 2009

(54) PLSMA DISPLAY APPARATUS

(76) Inventors: Jeongpil CHOI, Seoul (KR); Geunsoo LIM, Seoul (KR)

Correspondence Address: KED & ASSOCIATES, LLP, P.O. Box 221200, Chantilly, VA, 20153-1200, US

(21) Appl. No.: 12/260,294

(22) Filed: Oct. 29, 2008

(30) Foreign Application Priority Data
Oct. 29, 2007 (KR) 10-2007-0109086

(51) Int. Cl. G09G 3/28

(52) U.S. Cl. 345/60; 345/214

(57) ABSTRACT

A plasma display apparatus is disclosed. The plasma display apparatus includes a plasma display panel including a scan electrode and an address electrode, a scan driver that supplies a reset signal to the scan electrode during a reset period and supplies a scan signal to the scan electrode during an address period, a data driver that supplies a data signal synchronized with the scan signal to the address electrode, and an energy recovery unit that recovers an energy charged to the address electrode or supplies an energy to the address electrode. The amount of energy charged to the energy recovery unit changes depending on changes in video data. A minimum voltage of the scan signal is lower than a minimum voltage of the reset signal.

This application claims the benefit of Korean Patent Application No. 10-2007-0109086 filed on Oct. 29, 2007, which is hereby incorporated by reference.

### BACKGROUND

1. Field

Exemplary embodiments relate to a plasma display apparatus.

2. Description of the Background Art

A plasma display apparatus includes a plasma display panel and a driver. The plasma display panel has the structure in which barrier ribs formed between a front panel and a rear panel form unit discharge cell or a plurality of discharge cells. Each discharge cell is filled with an inert gas containing a main discharge gas such as neon (Ne), helium (He) or a mixture of Ne and He, and a small amount of xenon (Xe). The plurality of discharge cells form one pixel. For example, red, green, and blue discharge cells form one pixel. When the plasma display panel is discharged by applying a high frequency voltage to the discharge cell, the inert gas generates vacuum ultraviolet rays, which thereby cause phosphors between the barrier ribs to emit light, thus displaying an image. Since the plasma display panel can be manufactured to be thin and light, it has attracted attention as a next generation display device.

The driver is attached to the plasma display panel to drive electrodes of the plasma display panel.

### SUMMARY

In one aspect, a plasma display apparatus comprises a plasma display panel including a scan electrode and an address electrode, a scan driver that supplies a reset signal to the scan electrode during a reset period and supplies a scan signal to the scan electrode during an address period, a data driver that supplies a data signal synchronized with the scan signal to the address electrode, and an energy recovery unit that recovers an energy charged to the address electrode or supplies an energy to the address electrode, wherein the amount of energy charged to the energy recovery unit changes depending on changes in video data, wherein a minimum voltage of the scan signal is lower than a minimum voltage of the reset signal.

In another aspect, a plasma display apparatus comprises a plasma display panel including a scan electrode, a sustain electrode, and an address electrode, a scan driver that supplies a reset signal to the scan electrode during a reset period and supplies a scan signal to the scan electrode during an address period, a sustain driver that supplies a first sustain bias voltage to the sustain electrode during the supplying of the reset signal and supplies a second sustain bias voltage lower than the first sustain bias voltage to the sustain electrode during the address period, a data driver that supplies a data signal synchronized with the scan signal to the address electrode, and an energy recovery unit that recovers an energy charged to the address electrode or supplies an energy to the address electrode, wherein the amount of energy charged to the energy recovery unit changes depending on changes in video data, wherein a minimum voltage of the scan signal is lower than a minimum voltage of the reset signal.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 illustrates a plasma display apparatus according to an exemplary embodiment;

FIG. 2 illustrates a structure of a plasma display panel of the plasma display apparatus;

FIG. 3 illustrates a frame for achieving a gray level of an image in the plasma display apparatus;

FIG. 4 illustrates an operation of the plasma display apparatus;

FIG. 5 illustrates a scan signal supplied by a scan driver;

FIG. 6 illustrates a circuit configuration of a data driver including a data energy recovery unit and on- and off-cells;

FIG. 7 illustrates changes in a charging voltage and a data output of the data energy recovery unit depending on changes in video data;

FIG. 8 illustrates an operation of a data signal depending on changes in video data;

FIG. 9 illustrates a circuit configuration of a data driver according to another exemplary embodiment; and

FIGS. 10 and 11 illustrate a circuit configuration of a data driver according to another exemplary embodiment.

### DETAILED DESCRIPTION

Reference will now be made in detail embodiments of the invention examples of which are illustrated in the accompanying drawings.

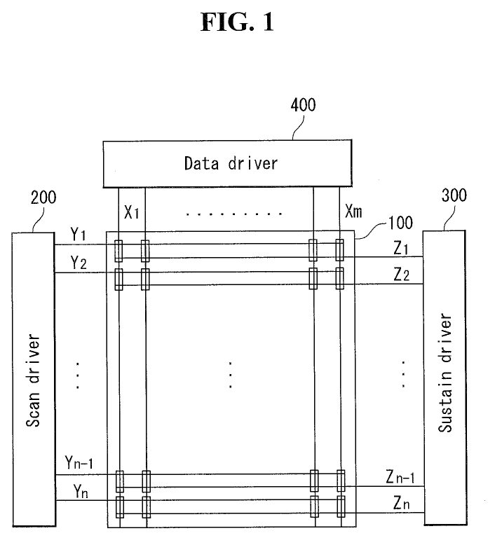

FIG. 1 illustrates a plasma display apparatus according to an exemplary embodiment.

As shown in FIG. 1, the plasma display apparatus according to the exemplary embodiment includes a plasma display panel 100 including electrodes and a driver. The driver includes a scan driver 200, a sustain driver 300, and a data driver 400.

The plasma display panel 100 includes a front panel (not shown) and a rear panel (not shown) which coalesce with each other at a given distance. The plasma display panel 100 includes scan electrodes Y1 to Yn, sustain electrodes Z1 to Zn, and address electrodes X1 to Xm.

The scan driver 200 supplies a reset signal to the scan electrodes Y1 to Yn during a reset period so that wall charges are uniformly accumulated inside discharge cells. The scan driver 200 supplies a scan signal to the scan electrodes Y1 to Yn during an address period so as to select the discharge cells to be turned on. A minimum voltage of the scan signal is a negative voltage lower than a minimum voltage of the reset signal. The scan driver 200 supplies a sustain signal to the scan electrodes Y1 to Yn during a sustain period so as to generate a sustain discharge inside the selected discharge cells.

The sustain driver 300 supplies a sustain bias voltage to the sustain electrodes Z1 to Zn during a set-down period and the address period. More specifically, the sustain driver 300 may supply a first sustain bias voltage to the sustain electrodes Z1 to Zn during the supplying of a reset falling signal of the reset signal to the scan electrodes Y1 to Yn, and may supply a second sustain bias voltage lower than the first sustain bias voltage to the sustain electrodes Z1 to Zn during the address period. The sustain driver 300 supplies a sustain signal to the sustain electrodes Z1 to Zn during the sustain period.

The data driver 400 supplies a data signal corresponding to the scan signal to the address electrodes X1 to Xm in response to a data timing control signal received from a timing controller (not shown) during the address period.

The data driver 400 including a data energy recovery unit recovers a voltage of the data signal from the address electrodes X1 to Xm in response to the scan signal, and supplies the recovered data signal, whose a voltage changes depending on changes in video data.

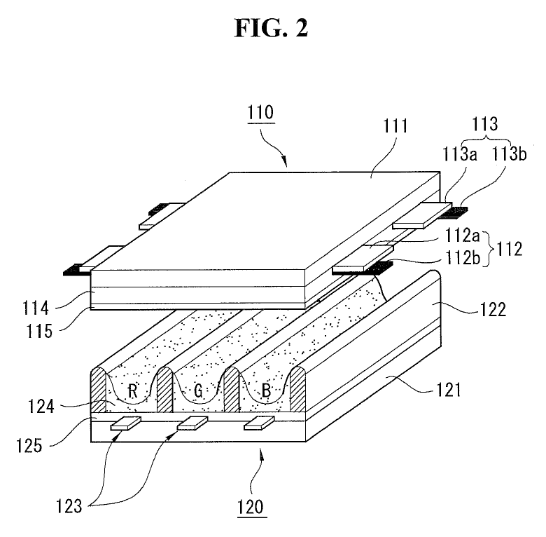

FIG. 2 illustrates a structure of a plasma display panel of the plasma display apparatus.

As shown in FIG. 2, the plasma display panel 100 includes a front panel 110 and a rear panel 120 which coalesce with each other at a given distance therebetween. The front panel 110 includes a front substrate 111 on which a scan electrode 112 and a sustain electrode 113 are positioned parallel to each other. The rear panel 120 includes a rear substrate 121 on which an address electrode 123 is positioned to cross the scan electrode 112 and the sustain electrode 113.

The scan electrode 112 and the sustain electrode 113 generate a discharge inside a discharge cell and keep the discharge inside the discharge cell.

A light transmittance and an electrical conductivity of the scan electrode 112 and the sustain electrode 113 need to be considered so as to emit light produced inside the discharge cells to the outside and to secure the driving efficiency. Accordingly, the scan electrode 112 and the sustain electrode 113 each include transparent electrodes 112a and 113a made of a transparent material, for example, indium-tin-oxide (ITO) and bus electrodes 112b and 113b made of a metal material such as silver (Ag).

An upper dielectric layer 114 covering the scan electrode 112 and the sustain electrode 113 is formed on the front substrate 111 on which the scan electrode 112 and the sustain electrode 113 are formed. The upper dielectric layer 114 limits discharge currents of the scan electrode 112 and the sustain electrode 113 and provides electrical insulation between the scan electrode 112 and the sustain electrode 113.

A protective layer 115 is formed on an upper surface of the upper dielectric layer 114 to facilitate discharge conditions. The protective layer 115 may be formed of a material with a high secondary electron emission coefficient, for example, magnesium oxide (MgO).

The address electrode 123 applies a data signal to the discharge cell.

A lower dielectric layer 125 covering the address electrode 123 is formed on the rear substrate 121 on which the address electrode 123 is formed.

Barrier ribs 122 are formed on the lower dielectric layer 125 to partition a discharge space, i.e., the discharge cell. A phosphor 124 for emitting visible light for an image display during an address discharge is formed inside the discharge cells partitioned by the barrier ribs 122. For example, red, green, and blue phosphors R, G, and B may be formed inside the discharge cells.

A discharge occurs inside the discharge cells by supplying driving signals to the scan electrode 112, the sustain electrode 113, and the address electrode 123, and thus an image is displayed on the plasma display panel 100.

Since FIG. 2 illustrated only an example of the plasma display panel applicable to the exemplary embodiment, the exemplary embodiment is not limited thereto.

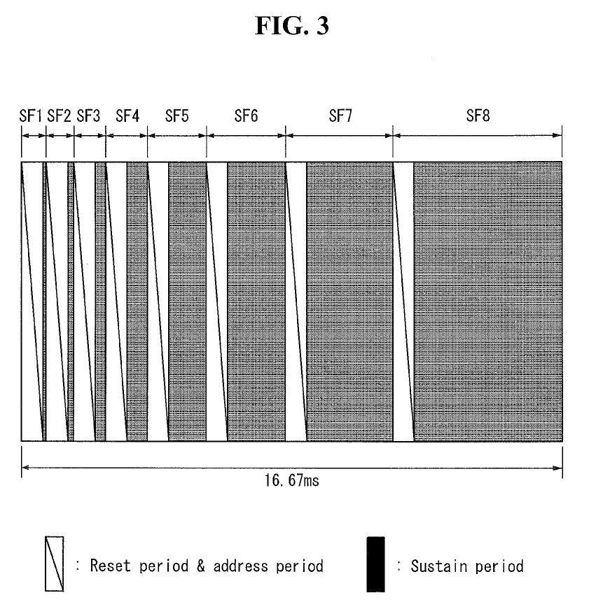

FIG. 3 illustrates a frame for achieving a gray level of an image in the plasma display apparatus.

As shown in FIG. 3, a frame for achieving a gray level of an image in the plasma display apparatus according to the exemplary embodiment is divided into a plurality of subfields each having a different number of emission times.

Each subfields may be subdivided into a reset period for initializing all the discharge cells, an address period for selecting cells to be discharged, and a sustain period for representing a gray level depending on the number of discharges.

For example, if an image with 256-level gray scale is to be displayed, a frame period (i.e., 16.67 ms) corresponding to 1/60 second, as shown in FIG. 3, is divided into 8 subfields SF1 to SF8. Each of the 8 subfields SF1 to SF8 is subdivided into a reset period, an address period, and a sustain period.

The number of sustain signals supplied during a sustain period of each subfield determines a gray level of each subfield. In other words, a predetermined gray level may be assigned to each subfield using the sustain period.

While one frame includes 8 subfields in FIG. 3, the number of subfields constituting one frame may variously change. For example, one frame may include 10 subfields or 12 subfields.

The image quality in the plasma display apparatus may depend on the number of subfields constituting a frame.

Further, while the subfields are arranged in increasing order of gray levels in FIG. 3, the subfields may be arranged in decreasing order of gray levels. Further, the subfields may be arranged regardless of the gray level so as to prevent a contour noise generated when an image is displayed.

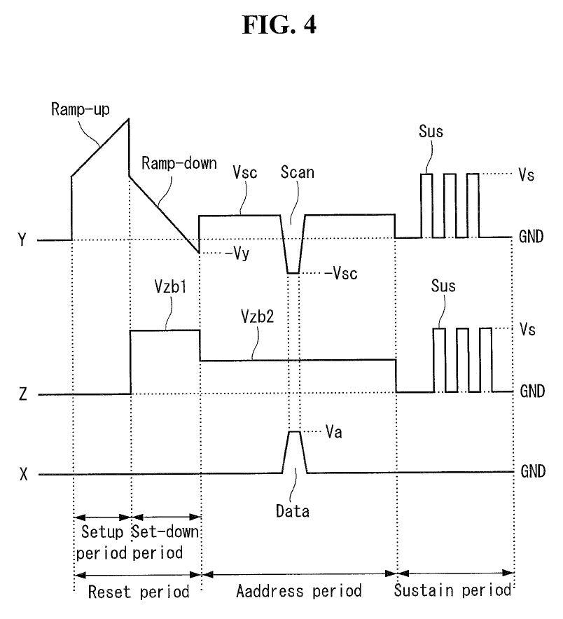

FIG. 4 illustrates an operation of the plasma display apparatus in any one of the plurality of subfields shown in FIG. 3.

The scan driver 200, the sustain driver 300, and the data driver 400 shown in FIG. 1 may supply driving signals to the scan electrode Y, the sustain electrode Z, and the address electrode X during at least one of a reset period, an address period, and a sustain period.

The reset period is divided into a setup period and a set-down period. During the reset period, the scan driver 200 supplies a reset signal including a reset rising signal Ramp-up and a reset falling signal Ramp-down to the scan electrode Y. During the setup period, the scan driver 200 supplies the reset rising signal Ramp-up to the scan electrode Y. The reset rising signal Ramp-up generates a weak dark discharge inside the discharge cells of the whole screen. Hence, wall charges of a positive polarity are accumulated on the sustain electrode Z and the address electrode X, and wall charges of a negative polarity are accumulated on the scan electrode Y.

During the set-down period, the scan driver 200 supplies the reset falling signal Ramp-down, which falls from a positive voltage level smaller than a maximum voltage of the reset rising signal Ramp-up to a given voltage level smaller than a ground level voltage GND, to the scan electrode Y, thereby generating a weak erase discharge inside the discharge cells. Hence, wall charges excessively accumulated inside the discharge cells are erased, and the remaining wall charges are uniformly distributed inside the discharge cells to the extent that an address discharge can stably occur.

The sustain driver 300 supplies a first sustain bias voltage Vzb1 to the sustain electrode Z during the set-down period, and supplies a second sustain bias voltage Vzb2 to the sustain electrode Z during an address period. The first and second sustain bias voltages Vzb1 and Vzb2 reduce a voltage difference between the sustain electrode Z and the scan electrode Y, thereby preventing an erroneous discharge from occurring between the sustain electrode Z and the scan electrode Y. The first sustain bias voltage Vzb1 may be larger than the second sustain bias voltage Vzb2.

During the address period, the scan driver 200 supplies a scan signal Scan of a negative polarity falling from a scan bias voltage Vsc to the scan electrode Y. The scan bias voltage Vsc is larger than the ground level voltage GND. More specifically, the scan bias voltage Vsc is higher than a minimum voltage −Vy of the reset falling signal Ramp-down, and is lower than a maximum voltage Vs of a sustain signal Sus. In other words, the scan signal Scan swings between the scan bias voltage Vsc and a voltage level lower than the minimum voltage −Vy of the reset falling signal Ramp-down.

The data driver 400 supplies a data signal Data of a positive polarity corresponding to the scan signal Scan of the negative polarity to the address electrode X.

As a voltage difference between the scan signal Scan and the data signal Data is added to a wall voltage produced during the reset period, an address discharge occurs inside the discharge cells to which the data signal Data is applied. Wall charges are distributed inside the discharge cells selected by performing the address discharge to the extent that when a sustain voltage Vs is applied, a discharge occurs.

During a sustain period, the scan driver 200 and the sustain driver 300 supply sustain signals Sus to the scan electrode Y and the sustain electrode Z, respectively. As a wall voltage inside the discharge cells selected by performing the address discharge is added to the sustain signal Sus, every time the sustain signal Sus is applied, a sustain discharge occurs between the scan electrode Y and the sustain electrode Z.

An erase period during which the remaining wall charges after the sustain discharge are erased may be added following the sustain period. Further, a pre-reset period during which wall charges are stably accumulated on the electrodes may be added prior to the reset period.

In FIGS. 1 to 4, the scan driver 200 and the sustain driver 300 operate independently of each other. However, the scan driver 200 and the sustain driver 300 may operate in the form of an integrated driver.

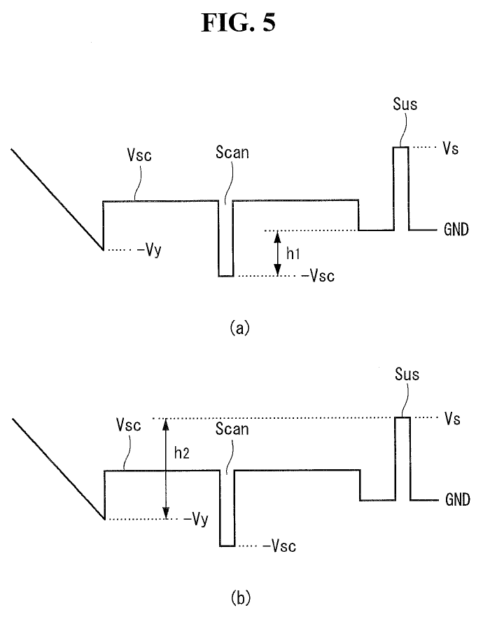

FIG. 5 illustrates the scan signal Scan supplied by the scan driver 200.

As shown in FIG. 5, the scan driver 200 supplies the scan signal Scan, whose a minimum voltage −Vsc is a negative voltage level lower than the minimum voltage −Vy of the reset signal supplied to the scan electrode Y during the reset period, to the scan electrode Y during the address period.

As shown in (a) of FIG. 5, the minimum voltage −Vy of the reset signal is lower than the minimum voltage GND of the sustain signal Sus supplied to the scan electrode Y during the sustain period and is higher than the minimum voltage −Vsc of the scan signal Scan supplied to the scan electrode Y during the address period. A range h1 of the minimum voltage −Vy of the reset signal has a value between the minimum voltage −Vsc of the scan signal Scan and the minimum voltage GND of the sustain signal Sus. Therefore, the minimum voltage −Vsc of the scan signal Scan is lower than the minimum voltage −Vy of the reset signal.

As above, because the minimum voltage −Vsc of the scan signal Scan is lower than the minimum voltage −Vy of the reset signal, a data voltage Va of the data signal Data can be lowered. As a result, heat generated in the data driver can be reduced and consumption power can be reduced.

As shown in (b) of FIG. 5, the scan signal Scan falls from the scan bias voltage Vsc. The scan bias voltage Vsc is lower than the maximum voltage Vs of the sustain signal Sus and is higher than the minimum voltage −Vy of the reset signal. A range h2 of the scan bias voltage Vsc has a value between the minimum voltage −Vy of the reset signal and the maximum voltage Vs of the sustain signal Sus.

Accordingly, the scan bias voltage Vsc may be a negative or positive voltage level depending on changes in a temperature of the plasma display panel and changes in surroundings of the plasma display panel. Because the scan bias voltage Vsc has a value between the minimum voltage −Vy of the reset signal and the maximum voltage Vs of the sustain signal Sus, the scan bias voltage Vsc can prevent an erroneous discharge from occurring by a voltage difference between the scan electrode Y and the sustain electrode Z during the address discharge.

Although it is not shown in FIG. 5, the first sustain bias voltage Vzb1 is supplied to the sustain electrode Z during the reset period, and the second sustain bias voltage Vzb2 lower than the first sustain bias voltage Vzb1 is supplied to the sustain electrode Z during the address period. Hence an erroneous discharge can be prevented from occurring by a voltage difference between the scan electrode Y and the sustain electrode Z during an address discharge.

The erroneous discharge can be efficiently prevented from occurring due to the voltage difference between the scan electrode Y and the sustain electrode Z during the address discharge by supplying the scan bias voltage Vsc between the minimum voltage −Vy of the reset signal and the maximum voltage Vs of the sustain signal Sus to the scan electrode Y and supplying the second sustain bias voltage Vzb2 to the sustain electrode Z. The first sustain bias voltage Vzb1 may be substantially equal to the maximum voltage Vs of the sustain signal Sus. The second sustain bias voltage Vzb2 may be higher than the ground level voltage GND and is lower than the maximum voltage Vs of the sustain signal Sus.

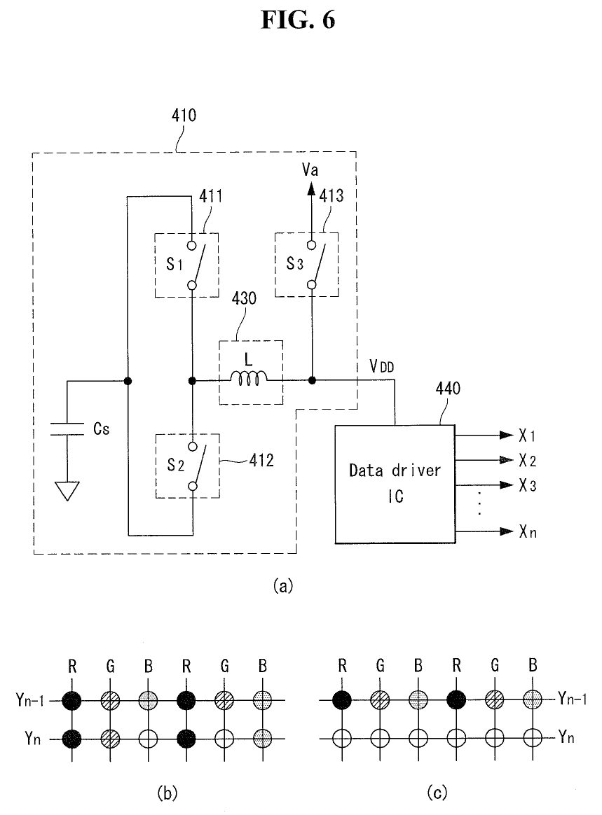

FIG. 6 illustrates a circuit configuration of a data driver including a data energy recovery unit and on- and off-cells.

In FIG. 6, (a) illustrates a circuit configuration of the data driver including a data energy recovery unit, and (b) and (c) illustrate on-cells and off-cells.

The data driver supplies a data signal synchronized with a scan signal to the address electrode. The data driver includes a data energy recovery unit 410 and a data driver integrated circuit (IC) 440.

The data energy recovery unit 410 recovers an energy of the data signal from the address electrode or supplies an energy to the address electrode. The amount of energy of the data signal recovered by the data energy recovery unit 410 changes depending on changes in video data.

The data energy recovery unit 410 includes an external capacitor Cs that recovers an energy of the data signal and charges the recovered energy, an inductor 430, and switching unit 411, 412 and 413. The inductor 430 and the external capacitor Cs form a resonance circuit. The switching units 411, 412 and 413 are connected to the external capacitor Cs and the inductor 430 to control charging and discharging operations the external capacitor Cs.

The switching units 411, 412 and 413 includes first and second switch units 411 and 412 connected in parallel between the external capacitor Cs and the inductor 430, and a third switch unit 413 connected between the inductor 430 and a data voltage source Va. The inductor 430 and the third switch unit 413 are commonly connected to the data driver IC 440.

In a related art data driver supplying a data signal to an address electrode, the data signal includes an Er_up operation in which a voltage of the data signal which has been charged to a data energy recovery unit is supplied to the address electrode, a Sus_up operation in which the data signal is hold at a data voltage corresponding to its maximum voltage, an Er_dn operation in which a voltage of the data signal is recovered from the address electrode, and a Sus_dn operation in which the data signal is hold at its minimum voltage.

However, in the data signal according to the exemplary embodiment, the Sus_dn operation is omitted, and the Er_up operation immediately follows the Er_dn operation. Hence, time required in the Sus_dn operation can be saved, and high speed driving can be achieved by a reduction in addressing time. Further, it is possible to automatically correspond to variable data patterns.

All the discharge cells of the scan electrode Yn_{—}1 are in an on-state in both cases of (b) and (c) of FIG. 6. In other words, all of output terminals of the data driver IC 440 are connected to switches (not shown) of a high state that are installed inside the data driver IC 440.

Two discharge cells of the scan electrode Yn are in an off-state in (b), and all the discharge cells of the scan electrode Yn are in an off-state in (c). In (b) of FIG. 6, because the two output terminals of the data driver IC 440 are connected to the switches (not shown) of a low state, the data energy recovery unit 410 recovers energy (i.e., the voltage of the data signal) charged to the two address electrodes. On the contrary, in (c) of FIG. 6, because all the output terminals are connected to the switches (not shown) of a low state, the data energy recovery unit 410 recovers the voltage of the data signal charged to all the address electrodes.

Accordingly, the amount of recovered voltage of the data signal changes depending on the number of on-discharge cells or the number of off-discharge cells.

Because the data driver according to the exemplary embodiment does not perform the Sus_dn operation, the energy of the data signal recovered by the data energy recovery unit 410 cannot be discharged and is stored.

In other words, the energy of the data signal recovered by the data energy recovery unit 410 changes depending on the number of on-discharge cells or the number of off-discharge cells.

For example, the amount of recovered energy of the data signal in (c) of FIG. 6 is more than the amount of recovered energy of the data signal in (b) of FIG. 6.

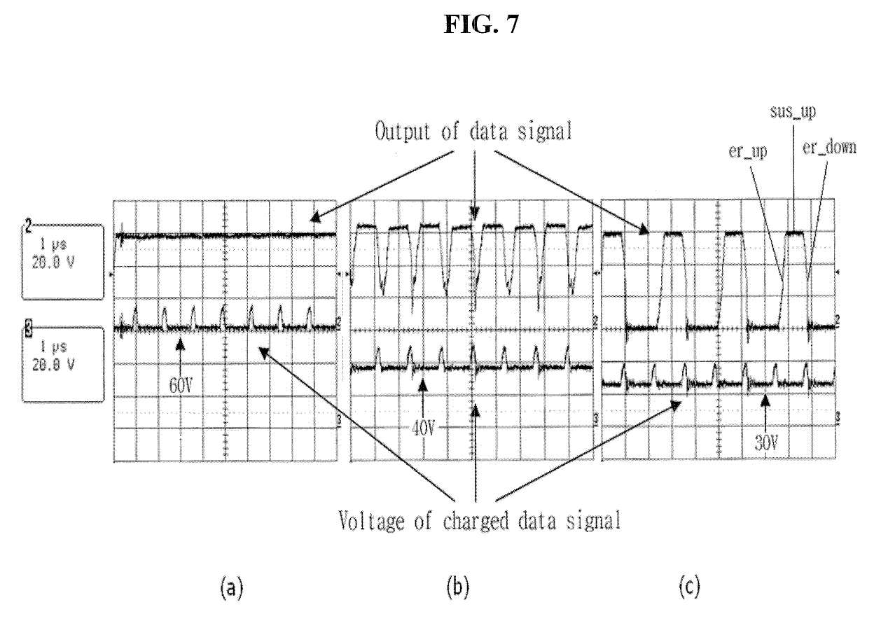

FIG. 7 illustrates changes in a charging voltage and a data output of the data energy recovery unit depending on changes in video data.

As shown in FIG. 7, (a) illustrates a state where there is no change in video data, i.e., a state of full white data, (b) illustrates a state where a change percentage of video data is about 50%, and (c) illustrates a state where a change percentage of video data is about 100%.

It can be seen from FIG. 7 that a total voltage of the data signal charged to the data energy recovery unit 410 changes. More specifically, a total voltage of the data signal is hold at about 60V, 40V, and 30V in (a), (b) and (c), respectively.

In (c) having the largest change percentage, since the data signal is supplied to the address electrode in an interlacing manner, supply and recovery operations of the voltage of the data signal in the data energy recovery unit 410 are balanced with each other. Therefore, the voltage of the data signal charged to the data energy recovery unit 410 is hold at one half of the data voltage (60V in FIG. 7).

On the contrary, in (a) in which full white data are continuously supplied, because the data energy recovery unit 410 does not perform the recovery operation of the voltage of the data signal, the voltage of the data signal charged to the data energy recovery unit 410 continuously increases. Hence, the voltage of the data signal is substantially equal to the data voltage Va.

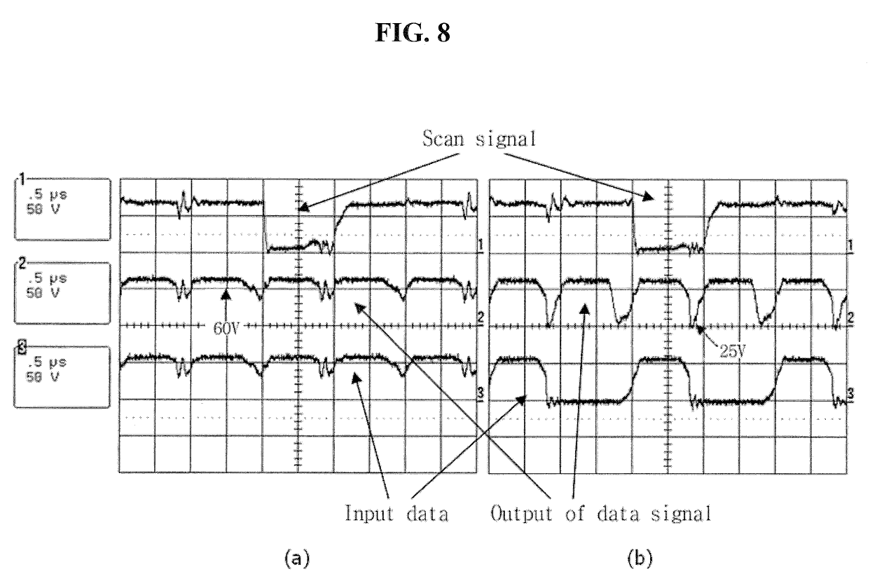

FIG. 8 illustrates an operation of a data signal depending on changes in video data.

As shown in FIG. 8, (a) illustrates an output of a data signal when video data is full white data, and Er_up and Er_dn operations are performed at about DC 50V. (b) illustrates an output of a data signal when the data signal is supplied in an interlacing manner, and Er_up and Er_dn operations are performed at about DC 25V.

In other words, in (a) of a state where the full white data is input, the voltage of the data signal is recovered, but the voltage of the data signal does not need to be again supplied. Accordingly, because the data energy recovery unit 410 performs only a charging operation, the voltage of the data signal charged to the data energy recovery unit 410 may increase to the data voltage Va.

On the contrary, in (b), because the data energy recovery unit 410 repeatedly performs recovery and supply operations, the voltage of the data signal charged to the data energy recovery unit 410 is one half of the data voltage Va and the data signal operates at one half of the data voltage Va.

After all, the data driver reduces power consumption caused by the voltage recovery operation of the data signal in the full-white state where the voltage recovery operation of the data signal is not necessary. In (b) in which the voltage recovery operation of the data signal is necessary, a normal voltage recovery operation of the data signal can be performed. The above operations are automatically controlled depending on the voltage of the data signal charged to the data energy recovery unit 410.

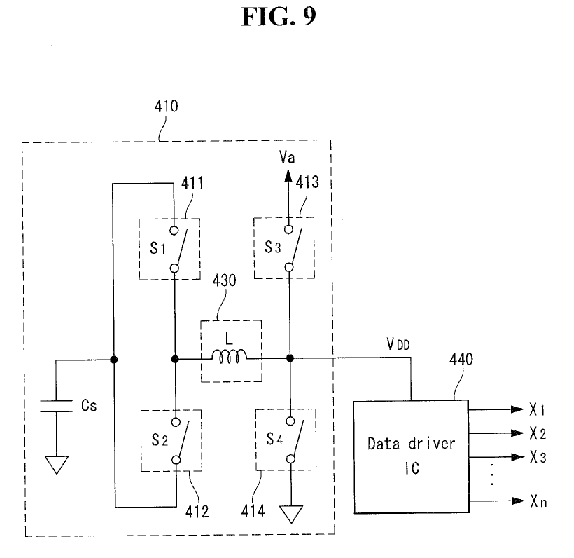

FIG. 9 illustrates a circuit configuration of a data driver according to another exemplary embodiment.

A data driver according to another exemplary embodiment includes a data energy recovery unit 410 and a data driver IC 440. Descriptions identical or equivalent to those described with reference to FIG. 6 will be omitted in FIG. 9.

As shown in FIG. 9, a switching unit includes first to fourth switch units 411 to 414. The first and second switch units 411 and 412 are connected in parallel between an external capacitor Cs and an inductor 430. The third switch unit 413 is connected between the inductor 430 and a data voltage source, and the fourth switch unit 414 is connected between the inductor 430 and a ground level voltage source. The inductor 430, the third switch unit 413, and the fourth switch unit 414 are commonly connected to the data driver IC 440.

As described above with reference to FIG. 6, the Sus_dn operation is omitted in the exemplary embodiment, and the Er_up operation immediately follows the Er_dn operation. However, in FIG. 9, the Sus_dn operation follows the Er_dn operation in each subfield or each frame because of the fourth switch unit 414. Hence, a reset operation of the data energy recovery unit 410 can be performed.

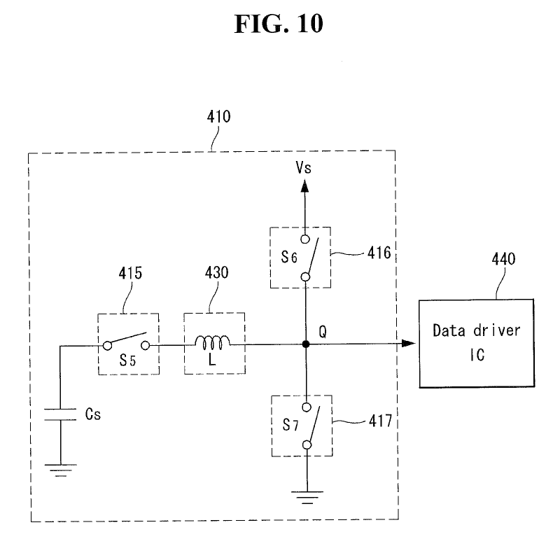

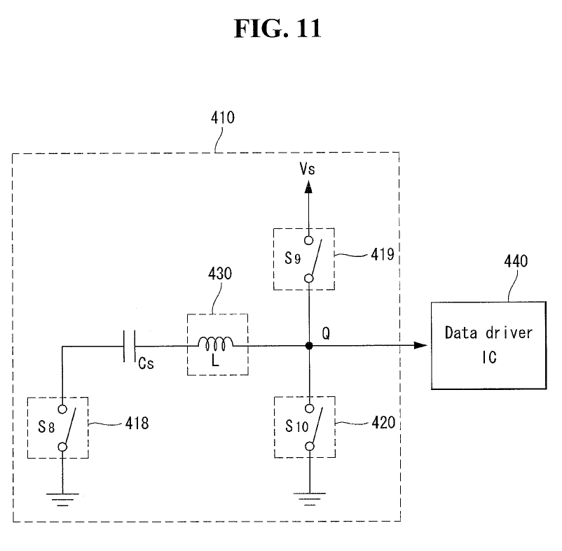

FIGS. 10 and 11 illustrate a circuit configuration of a data driver according to another exemplary embodiment.

A data driver according to another exemplary embodiment includes a data energy recovery unit 410 and a data driver IC 440. Since a data energy recovery unit 410 and an inductor 430 shown in FIGS. 10 and 11 are substantially the same as those of FIG. 6, a description thereof is omitted.

As shown in FIG. 10, a switching unit includes fifth to seventh switch units 415 to 417. The fifth switch unit 415 is connected between the inductor 430 and an external capacitor Cs, the sixth switch unit 416 is connected between the inductor 430 and a data voltage source, and the seventh switch unit 417 is connected between the inductor 430 and a ground level voltage source.

The data energy recovery unit 410 having the above configuration of FIG. 10 can perform voltage supply and recovery operations of the data signal using only the fifth and sixth switch units 415 and 416.

In other words, a resonance waveform is formed by performing an Er_dn operation, and a Sus_up operation is naturally performed when the data signal reaches a peak value. Hence, the voltage of the data signal rises. When the data energy recovery unit 410 ideally operates, the data energy recovery unit 410 is charged to one half of the data voltage Va.

A resonance waveform generates between the data voltage Va and the ground level voltage GND based on one half of the data voltage Va. Accordingly, the Sus_dn and Er_up operations are not separately necessary. In other words, not the four switch units but the two switch units can perform the voltage supply and recovery operations of the data signal using a natural resonance waveform.

A switching unit of FIG. 11 includes eighth to tenth switch units 418 to 420. An external capacitor Cs is connected between the eighth switch unit 418 and an inductor 430, the ninth switch unit 419 is connected between the inductor 430 and a data voltage source, and the tenth switch unit 420 is connected between the inductor 430 and a ground level voltage source.

The data energy recovery unit 410 having the above configuration of FIG. 11 can perform voltage supply and recovery operations of the data signal using only the eighth and ninth switch units 418 and 419. The circuit configuration of FIG. 10 is different from the circuit configuration of FIG. 11 in that positions of the eighth switch unit 418 and the external capacitor Cs are reversed. The position change is possible because the eighth switch unit 418 and the data energy recovery unit 410 are connected in series.

Because the eighth switch unit 418 is directly connected to a ground level, the eighth switch unit 418 may directly use a control signal.

Since functions of the seventh switch unit 417 of FIG. 10 and the tenth switch unit 420 of FIG. 11 are substantially the same as a function of the fourth switch unit 414 of FIG. 9, a description thereof is omitted.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel including a scan electrode and an address electrode;
a scan driver that supplies a reset signal to the scan electrode during a reset period and supplies a scan signal to the scan electrode during an address period;
a data driver that supplies a data signal synchronized with the scan signal to the address electrode; and
an energy recovery unit that recovers an energy charged to the address electrode or supplies an energy to the address electrode,
wherein the amount of energy charged to the energy recovery unit changes depending on changes in video data,
wherein a minimum voltage of the scan signal is lower than a minimum voltage of the reset signal.

2. The plasma display apparatus of claim 1, wherein the minimum voltage of the reset signal is lower than a ground level voltage.

3. The plasma display apparatus of claim 1, wherein the scan driver supplies a scan bias voltage to the scan electrode, and the scan bias voltage is higher than a ground level voltage.

4. The plasma display apparatus of claim 3, wherein the scan signal swings between the scan bias voltage and a voltage lower than the minimum voltage of the reset signal.

5. The plasma display apparatus of claim 1, wherein the energy recovery unit includes:
an external capacitor that recovers an energy of the data signal supplied to the address electrode and charges the recovered energy;
an inductor that forms a resonance circuit together with the external capacitor; and
a switching unit that controls charging and discharging operations of the external capacitor.

6. The plasma display apparatus of claim 5, wherein the switching unit includes:
first and second switch units that are connected in parallel between the external capacitor and the inductor; and
a third switch unit that is connected between the inductor and a data voltage source.

7. The plasma display apparatus of claim 6, wherein the inductor and the third switching unit are commonly connected to a data driver integrated circuit (IC).

8. The plasma display apparatus of claim 6, wherein the switching unit further includes a fourth switch unit connected between the inductor and a ground level voltage source,
wherein the fourth switch unit is commonly connected to the inductor and the third switch unit.

9. The plasma display apparatus of claim 5, wherein the switching unit includes:
a fifth switch unit connected between the inductor and the external capacitor;
a sixth switch unit connected between the inductor and a data voltage source; and
a seventh switch unit connected between the inductor and a ground level voltage source.

10. The plasma display apparatus of claim 5, wherein the switching unit includes eighth to tenth switch units,
wherein the external capacitor is connected between the eighth switch unit and the inductor, the ninth switch unit is connected between the inductor and a data voltage source, and the tenth switch unit is connected between the inductor and a ground level voltage source.

11. A plasma display apparatus comprising:
a plasma display panel including a scan electrode, a sustain electrode, and an address electrode;
a scan driver that supplies a reset signal to the scan electrode during a reset period and supplies a scan signal to the scan electrode during an address period;
a sustain driver that supplies a first sustain bias voltage to the sustain electrode during the supplying of the reset signal and supplies a second sustain bias voltage lower than the first sustain bias voltage to the sustain electrode during the address period;
a data driver that supplies a data signal synchronized with the scan signal to the address electrode; and
an energy recovery unit that recovers an energy charged to the address electrode or supplies an energy to the address electrode,
wherein the amount of energy charged to the energy recovery unit changes depending on changes in video data,
wherein a minimum voltage of the scan signal is lower than a minimum voltage of the reset signal.

12. The plasma display apparatus of claim 11, wherein the first sustain bias voltage is substantially equal to a maximum voltage of a sustain signal,
wherein the second sustain bias voltage is higher than a ground level voltage and is lower than the maximum voltage of the sustain signal.

13. The plasma display apparatus of claim 11, wherein the minimum voltage of the reset signal is lower than a ground level voltage.

14. The plasma display apparatus of claim 11, wherein the scan driver supplies a scan bias voltage to the scan electrode, and the scan bias voltage is higher than a ground level voltage.

15. The plasma display apparatus of claim 14, wherein the scan signal swings between the scan bias voltage and a voltage lower than the minimum voltage of the reset signal.

16. The plasma display apparatus of claim 11, wherein the energy recovery unit includes:
an external capacitor that recovers an energy of the data signal supplied to the address electrode and charges the recovered energy;
an inductor that forms a resonance circuit together with the external capacitor; and
a switching unit that controls charging and discharging operations of the external capacitor.

17. The plasma display apparatus of claim 16, wherein the switching unit includes:
first and second switch units that are connected in parallel between the external capacitor and the inductor; and
a third switch unit that is connected between the inductor and a data voltage source.

18. The plasma display apparatus of claim 17, wherein the switching unit further includes a fourth switch unit connected between the inductor and a ground level voltage source,
wherein the fourth switch unit is commonly connected to the inductor and the third switch unit.

19. The plasma display apparatus of claim 16, wherein the switching unit includes:
a fifth switch unit connected between the inductor and the external capacitor;
a sixth switch unit connected between the inductor and a data voltage source; and
a seventh switch unit connected between the inductor and a ground level voltage source.

20. The plasma display apparatus of claim 16, wherein the switching unit includes eighth to tenth switch units,
wherein the external capacitor is connected between the eighth switch unit and the inductor, the ninth switch unit is connected between the inductor and a data voltage source, and the tenth switch unit is connected between the inductor and a ground level voltage source.
